(19) United States
(12) Patent Application Publication
(10) Pub. No.: US 2018/0150918 A1
(43) Pub. Date: May 31, 2018

(54) MANAGEMENT SYSTEM FOR REGISTERING AND MANAGING PROGRESS OF NEGOTIATIONS OR THE LIKE AND CUSTOMER INFORMATION TO IMPROVE BUSINESS EFFICIENCY, AND A METHOD FOR SAME

(71) Applicant: Nippon Gas Co., LTD., Tokyo (JP)

(72) Inventors: Shinji Wada, Tokyo (JP); Shingo Dekamo, Tokyo (JP)

(21) Appl. No.: 15/576,571

(22) PCT Filed: Apr. 11, 2016
(86) PCT No.: PCT/JP2016/001974

§ 371 Date: Nov. 22, 2017

(30) Foreign Application Priority Data
Jun. 29, 2015 (JP) 2015-130471

(51) Int. Cl. G06Q 50/06; G06Q 20/40

(52) U.S. Cl. CPC G06Q 50/06; G06Q 20/4014

(57) ABSTRACT

The present invention provides a management system in which a management server receives an access request from a mobile terminal and sends a negotiation data list showing a list of customers in the middle of the negotiation and an input template to the mobile terminal. The mobile terminal sends an input template for which a user input to the input template is received and the user instruction to a management server. When the management server receives a user instruction for updating a data list, then the management server updates the negotiation data list based on the received input template. When the management server receives a user instruction showing the completion of the input, then the management server newly creates formal registration information regarding the customer and reflects the input template for which the user input is completed on the formal registration information.

### TECHNICAL FIELD

The present invention relates to a management system and the method thereof. More particularly, the invention relates to a management system and the method thereof by which an efficient business transaction is provided by registering and managing the progress situation of a negotiation for example and customer information.

### BACKGROUND ART

When a business transaction related to a gas contract is carried out to a customer for whom a gas contract is not yet executed or a customer who is considering changing the gas supply company, then a business transaction representative visits the home of the customer to negotiate a contract with the customer. After the contract is concluded with the customer through the negotiation, then the business transaction representative returns to a business transaction headquarter and uses a client computer to register, in a management server, the formal registration information related to the customer.

### SUMMARY OF INVENTION

### Technical Problem

However, there has conventionally been no system to register and manage negotiation information regarding the negotiation progress situation or customer information regarding a customer in the middle of negotiation. Thus, a deliveryman, a meter reader, and a safety inspector for example participate as a business transaction representative in a gas supply-related negotiation. This requires, when the negotiation is temporarily stopped and another business transaction representative later visits the customer home to resume the negotiation, the another business transaction representative to share the negotiation information and customer information with the previous business transaction representative by exchanging the information therebetween. This sharing requires a time. Thus, a system has been desired that allows business transaction representatives to share the information.

When a contract is concluded, then the business transaction representative must refer to contract documents for example to input all of the formal registration information related to the customer for whom the contract is concluded, thus requiring time and effort. Thus, a system has been desired that provides the simple registration of the formal registration information related to the customer.

As described above, there has conventionally been no system to provide a higher work efficiency in the negotiation while registering and managing the negotiation information and customer information for each customer, causing a difficulty in providing an improved work efficiency in the negotiation.

The present invention has been made in view of the above. It is an objective to provide a management system to provide an improved business transaction by registering and managing the negotiation information and customer information to transfer these pieces of information as the formal registration information, as well as the method thereof.

### Solution to Problem

In order to solve the above disadvantage, a management system according to one embodiment of the present invention is characterized in that a management system comprising a management server and a mobile terminal that can communicate with the management server via a network, the management server is configured to: receive an access request from the mobile terminal via the network, the access request including a business office identifier for identifying a business office to which a business transaction representative belongs, and a business transaction representative identifier and an authentication password for identifying the business transaction representative, determine whether or not the access request is valid based on the business transaction representative identifier and the authentication password, and send, when it is determined that the access request is valid, a negotiation data list showing a list of customers in the middle of the negotiation and a customer information input template to the mobile terminal, the negotiation data list being associated with the business office identifier, the mobile terminal is configured to: receive the negotiation data list and the customer information input template, display the customer information input template, receive a user input to the customer information input template, send, when receiving a user instruction for updating the customer information input template, a customer information input template for which the user input was received and the user instruction for the update to the management server, and send, when receiving a user instruction showing that the user input for the customer information input template is completed, the customer information input template for which the user input is completed and the user instruction showing the completion to the management server, the management server is configured to: update, when receiving the user instruction for the update, the negotiation data list based on the customer information input template, and newly create, when receiving the user instruction showing the completion, formal registration information regarding the customer to reflect the customer information input template for which the user input is completed on the formal registration information.

A method according to another embodiment of the present invention is characterized in that a method carried out in a management system including a management server and a mobile terminal that can communicate with the management server via a network, the method comprising: receiving, by the management server, an access request from the mobile terminal via the network, the access request including a business office identifier for identifying a business office to which a business transaction representative belongs and a business transaction representative identifier and an authentication password for identifying the business transaction representative, determining, the management server, whether or not the access request is valid based on the business transaction representative identifier and the authentication password, sending, by the management server, a negotiation data list showing a list of customers in the middle of the negotiation and a customer information input template to the mobile terminal when the management server determines that the access request is valid, the negotiation data list being associated with the business office identifier, receiving, by the mobile terminal, the negotiation data list and the customer information input template, displaying, by the mobile terminal, the customer information input template, receiving, by the mobile terminal, the user input to the customer information input template, sending, by the mobile terminal, a customer information input template for which the user input was received and the user instruction for the update to the management server when the mobile terminal receives a user instruction for updating the customer information input template, sending, by the mobile terminal, the customer information input template for which the user input is completed and the user instruction showing the completion to the management server when the mobile terminal receives a user instruction showing that the user input for the customer information input template is completed, updating, by the management server, the negotiation data list based on the customer information input template when the management server receives the user instruction for the update, and newly creating, by the management server, formal registration information regarding the customer to reflect the customer information input template for which the user input is completed on the formal registration information when the management server receives the user instruction showing the completion.

### Advantageous Effects of Invention

According to the present invention, when information related to negotiation, contract conclusion, and closing or customer information is registered and managed and the contract is concluded, then the customer information is reflected on the formal registration information and is registered, thereby providing a management system for providing an improved business transaction and the method thereof.

### BRIEF DESCRIPTION OF THE DRAWINGS

FIG. 1 illustrates one example of a network configuration in a management system according to the present invention;

FIG. 2A illustrates a negotiation management map displayed by a mobile terminal;

FIG. 2B illustrates a detailed screen of the negotiation management map displayed by the mobile terminal;

FIG. 3A illustrates a menu screen displayed by the mobile terminal;

FIG. 3B displays the menu screen displayed by the mobile terminal;

FIG. 3C displays the menu screen displayed by the mobile terminal;

FIG. 3D displays the menu screen displayed by the mobile terminal;

FIG. 4 shows the relation between FIG. 4A and FIG. 4B;

FIG. 4A illustrates a new input template;

FIG. 4B illustrates the new input template;

FIG. 5 shows the relation between FIG. 5A and FIG. 5B;

FIG. 5A illustrates a detailed screen for new negotiation information;

FIG. 5B illustrates the detailed screen for the new negotiation information;

FIG. 6 illustrates the relation between FIG. 6A and FIG. 6B;

FIG. 6A illustrates a contract conclusion input template for the transfer from the new input template;

FIG. 6B illustrates the contract conclusion input template for the transfer from the new input template;

FIG. 7A illustrates a search screen;

FIG. 7B illustrates the search screen;

FIG. 7C illustrates the search screen;

FIG. 8 illustrates the relation among FIG. 8A, FIG. 8B, and FIG. 8C;

FIG. 8A illustrates a switch input template;

FIG. 8B illustrates the switch input template;

FIG. 8C illustrates the switch input template;

FIG. 9 illustrates the relation between FIG. 9A and FIG. 9B;

FIG. 9A illustrates the contract conclusion input template for the transfer from the switch input template;

FIG. 9B illustrates the contract conclusion input template for the transfer from the switch input template;

FIG. 10 illustrates the relation between FIG. 10A and FIG. 10B;

FIG. 10A illustrates a closing input template;

FIG. 10B illustrates the closing input template;

FIG. 11 illustrates a detailed screen showing the details of a contract conclusion situation;

FIG. 12 illustrates the relation between FIG. 12A and FIG. 12B;

FIG. 12A illustrates the detailed screen showing the details of the closing situation;

FIG. 12B illustrates the detailed screen showing the details of the closing situation;

FIG. 13 illustrates the relation between FIG. 13A and FIG. 13B;

FIG. 13A illustrates a data output screen of a client computer; and

FIG. 13B illustrates the data output screen of the client computer.

### DESCRIPTION OF EMBODIMENTS

### Network Configuration Example

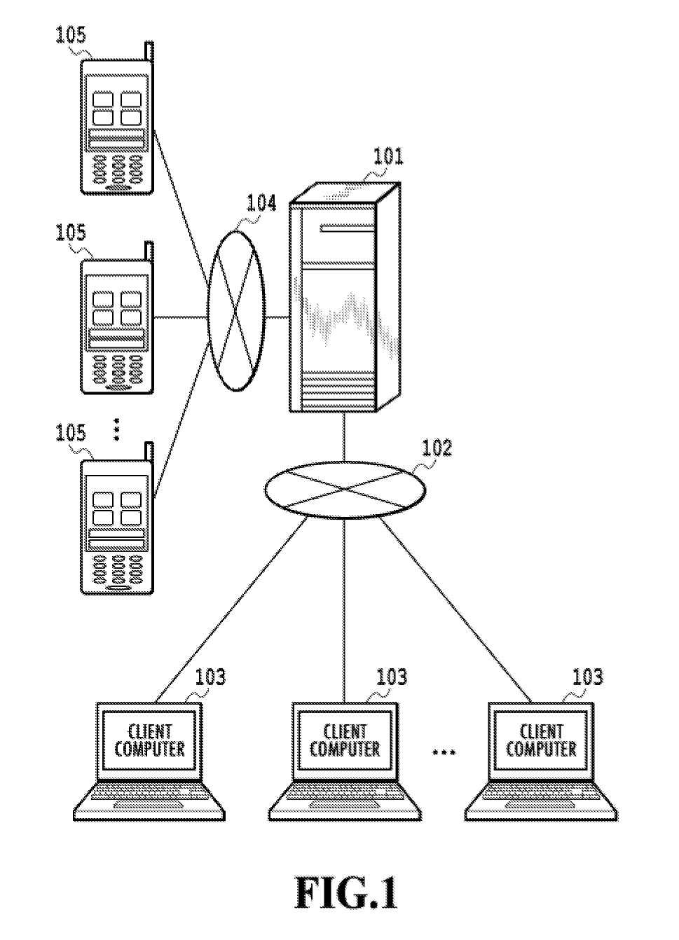

FIG. 1 illustrates one example of a network configuration in a management system according to the present invention. In FIG. 1, a management server 101 is configured to be able to communicate with a plurality of client computers 103 via a network 102. The management server 101 is also configured to be able to communicate with a plurality of mobile terminals (communication terminals) 105 via a network 104.

The client computer 103 is a terminal provided in a distribution center to manage the distribution in each distribution base in a centralized manner for example. The client computer 103 can be connected to the management server 101 via the network 102.

The mobile terminal 105 is a terminal used by a business transaction representative (or a meter reader, a deliveryman, or a safety inspector for example) carrying out a gas contract-related negotiation and includes a CPU, a memory, an input apparatus, and a display apparatus for example. The mobile terminal 105 can send negotiation information including a negotiation situation to the management server 101 via the network 104. The mobile terminal 105 also can be a smart phone such as an Android terminal and stores a negotiation application related to the negotiation management according to the present invention in a memory.

### Example 1

The following section will describe the management system according to an embodiment of the present invention. As described above, the mobile terminal 105 stores a negotiation application related to the negotiation management according to the present invention in a memory. The mobile terminal 105 can activate the negotiation application by touching an icon of the negotiation application displayed by the mobile terminal 105 for example.

When the negotiation application is activated, then the mobile terminal 105 sends an access request to the management server 101 via the network 104. The access request includes a business office identifier for identifying a business office to which a business transaction representative belongs and a business transaction representative identifier for identifying a business transaction representative and a password.

The management server 101 determines whether or not the access request is for a valid access based on the business transaction representative identifier and the password. When the result shows that the access request is determined to be not for a valid access, then the management server 101 completes the processing. When the access request is determined as the one for a valid access, then the management server 101 sends a negotiation data list showing customer(s) in the middle of the negotiation and a customer information input template to the mobile terminal 105. The negotiation data list is associated with the business office identifier and includes a new negotiation data list showing customer(s) for whom a new negotiation is being continued, a switch negotiation data list showing customer(s) for whom a switch negotiation is being continued, a contract conclusion data list showing customer(s) for whom a contract is in the middle of the conclusion, and a closing data list showing customer(s) in the middle of the closing process. The customer information input template includes a new input template to input new negotiation information related to a new negotiation, a switch input template to input switch negotiation information related to a switch negotiation, a contract conclusion input template to input contract conclusion information relates to a contract conclusion, a closing input template to input closing information related to the closing, and a search condition input template to input search condition(s). By sending the negotiation data list associated with the business office identifier to the mobile terminal 105, the negotiation information and the customer information can be shared among the respective business offices.

When the above determination result shows that the request is for a valid access, then the management server 101 receives a map of the periphery of the mobile terminal 105 from the map provision server. The management server 101 creates, based on the received map of the periphery of the mobile terminal 105, a negotiation management map showing the negotiation situation of a building at the periphery of the mobile terminal 105 to send the negotiation management map to the mobile terminal 105. The management server 101 can receive the periphery map from a map provision server of Zenrin for example. The mobile terminal 105 responds to the reception of the negotiation management map to display the negotiation management map.

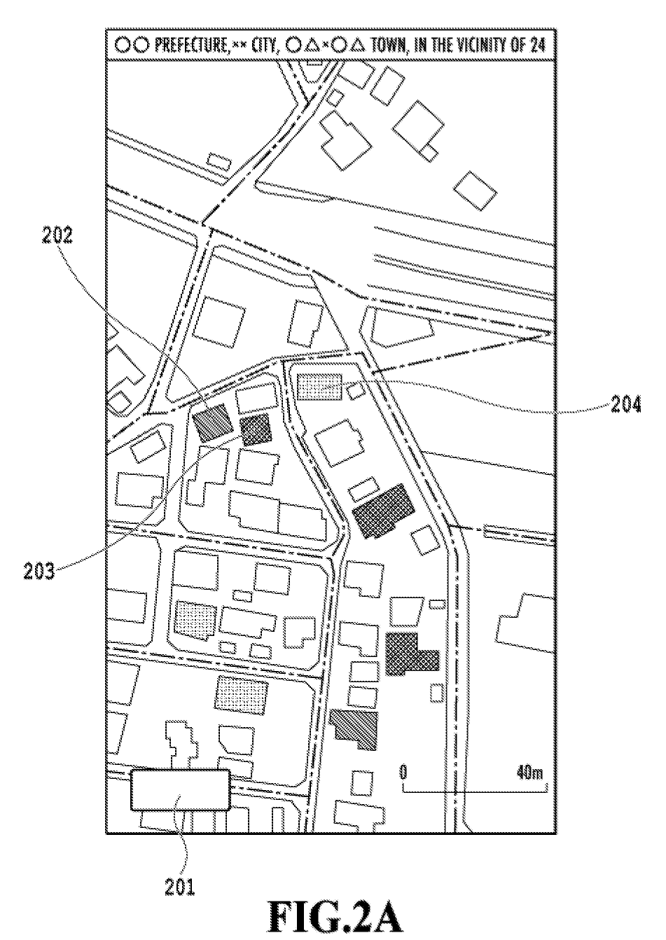

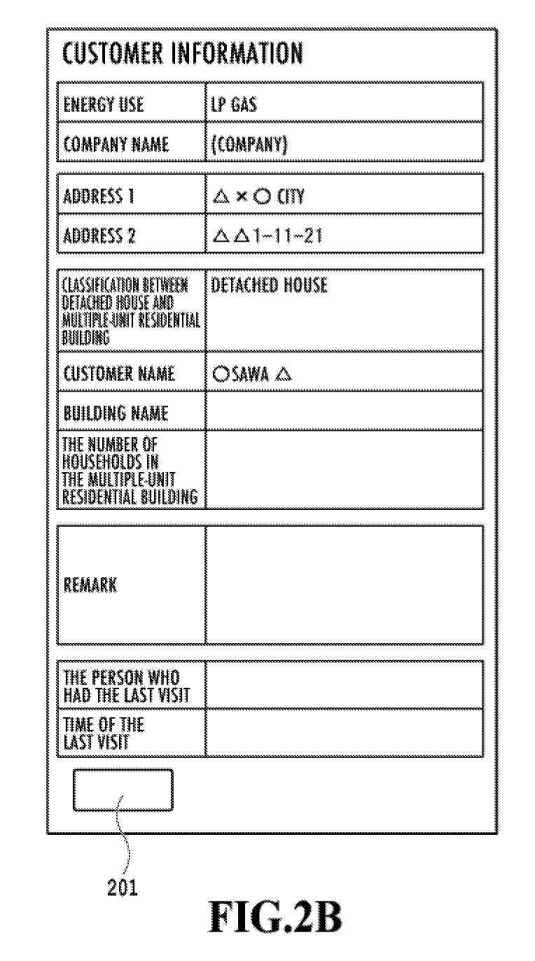

FIG. 2A illustrates the negotiation management map displayed by the mobile terminal 105. As shown in FIG. 2A, the negotiation management map displays a plurality of buildings from which a building can be selected via touch input. When a building is selected from the negotiation management map, then the selected building is displayed in a highlighted manner. When the building is selected again for example, then customer information regarding the selected building is displayed as shown in FIG. 2B.

The negotiation management map can display, from among a plurality of buildings displayed on the negotiation management map, buildings having specific contract and negotiation such as a building 202 having a contract with another gas supply company, a building 203 having a contract with the company, and a building 204 in the middle of the negotiation by different display methods, respectively. A building for which negotiation data is not yet inputted is displayed by a usual display method. This allows the business transaction representative to visually determine the contract or negotiation situation of the periphery building, thus providing an efficient business transaction.

As shown in FIGS. 2A and 2B, the negotiation management map includes a menu key 201. When the menu key 201 in negotiation management map is selected by being touched, then the menu screen is displayed by the mobile terminal 105.

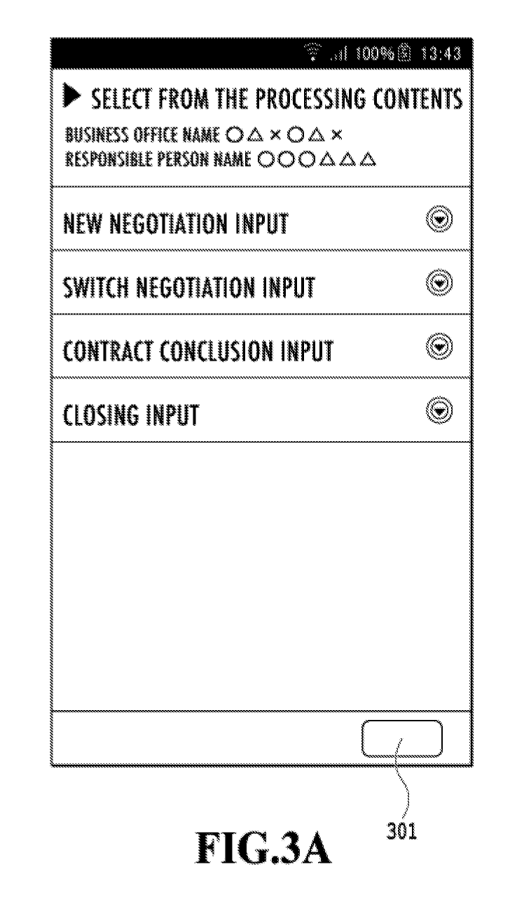

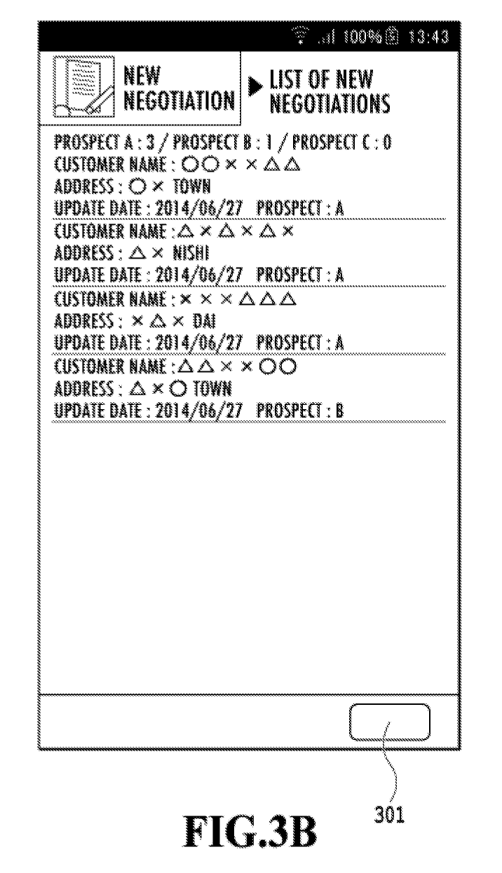

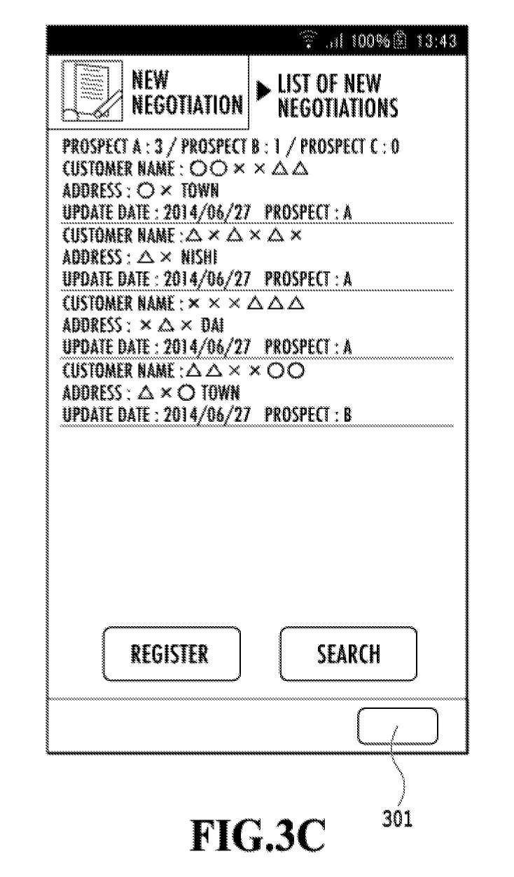

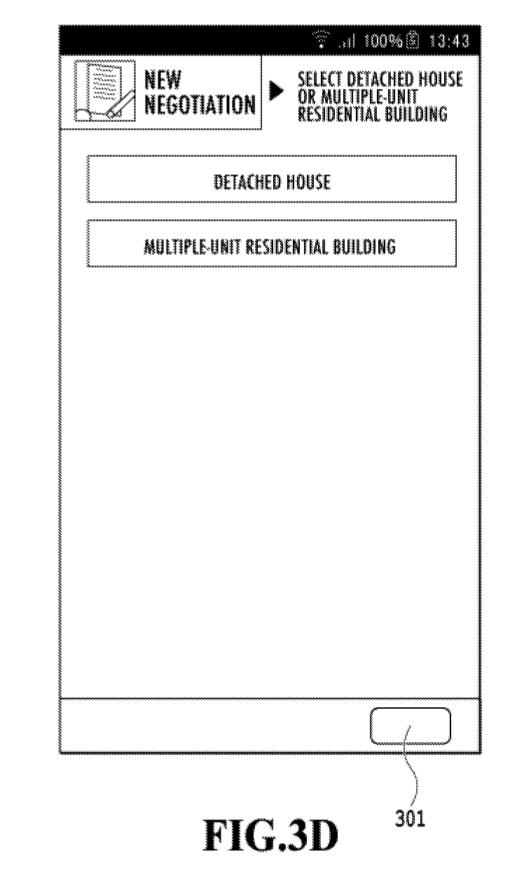

FIG. 3A illustrates the menu screen displayed by the mobile terminal 105. Items displayed on this menu screen can include, for example, a new negotiation input item for managing the negotiation with a customer for which a contract with any gas supply company has been not yet concluded, a switch negotiation input item for managing the negotiation for the switching from another company, a contract conclusion input item for managing the contract conclusion of a new negotiation or a switch negotiation, and a closing input item for managing the closing of a switch negotiation.

In the above description, an example was described in which the mobile terminal 105 receives, in addition to the negotiation data list and the customer information input template, the negotiation management map to select a menu key in the negotiation management map to thereby display the menu screen. However, another configuration also may be used in which the mobile terminal 105 receives only the negotiation data list and the customer information input template to directly transfer to the menu screen.

### From New Negotiation to Contract Conclusion

First, the following section will describe the flow of the management system of the present invention from a new negotiation to the contract conclusion.

When the new negotiation input item is selected from the menu screen, the mobile terminal 105 displays the new negotiation data list from among the negotiation data list of the business transaction representatives received from the management server 101 as shown in FIG. 3B. The customer-related record displayed on the new negotiation data list represents a customer in the middle of the new negotiation.

In order to start the data input of the new negotiation information, a function key 301 on the screen is selected. When the function key 301 is selected, then a “register” key and a “search” key are displayed as shown in FIG. 3C. The “register” key is a soft key to start the negotiation for a new customer. The “search” key is a soft key to search a customer in the middle of the negotiation based on an arbitrary condition.

When assuming that the “register” key is selected in order to start the negotiation for the new customer, then the mobile terminal 105 displays a screen to select whether the newly-negotiated building applies to a “detached house” key or a “multiple-unit residential building” key as shown in FIG. 3D. When any of the “detached house” key or the “multiple-unit residential building” key is selected, then the mobile terminal 105 displays a new input template that corresponds to the selected one among the “detached house” key or the “multiple-unit residential building” key.

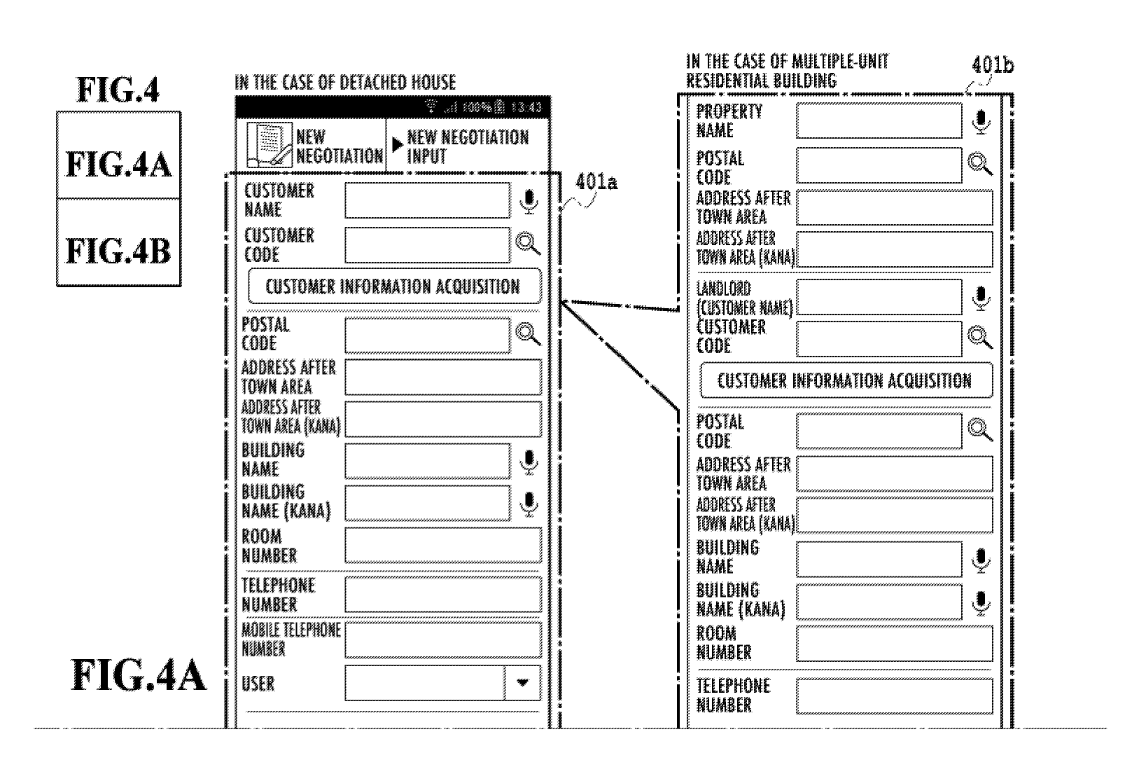

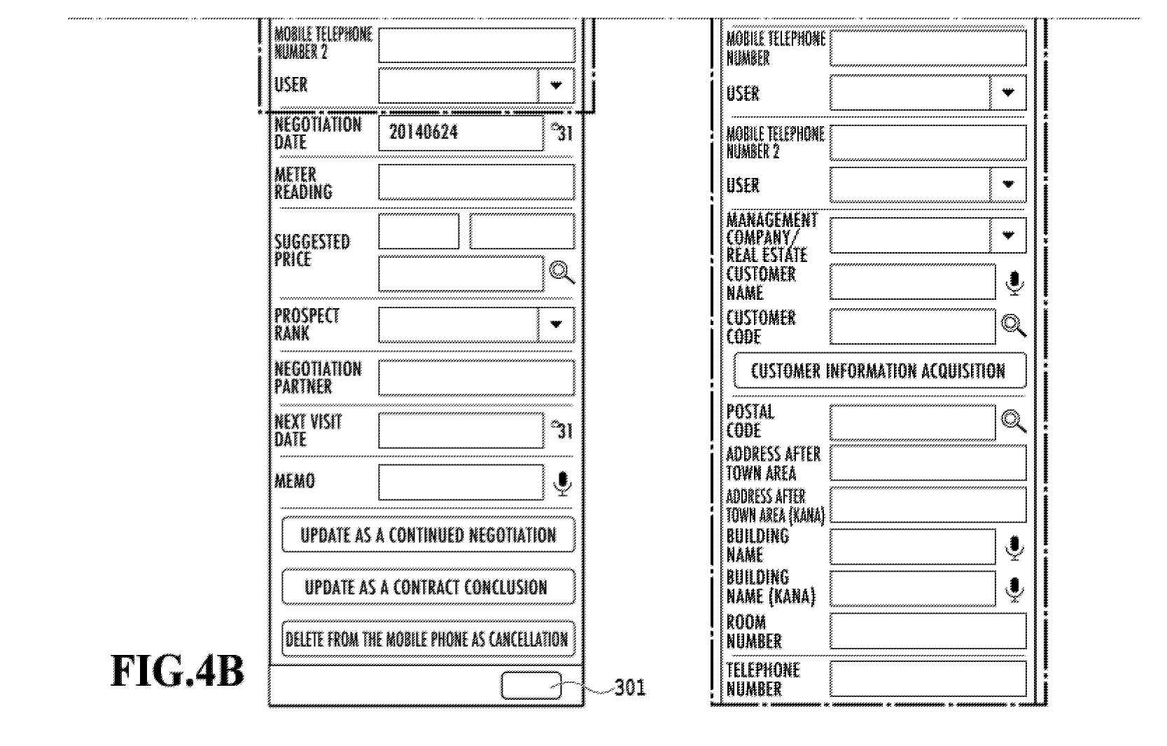

FIGS. 4A and 4B illustrate the new input template. As shown in FIGS. 4A and 4B, the “detached house”-related new input template and the “multiple-unit residential building”-related new input template are different only in the portions for input item groups 401a and 401b and the other portions are the same therebetween. In order to input customer information related to an existing customer, then the customer information acquisition in FIGS. 4A and 4B can be selected to thereby automatically input the customer information.

In FIGS. 4A and 4B, the “user” can be selected from among the input items for the identical person, the husband, the wife, and a child, and other persons for example. In FIGS. 4A and 4B, the input item for the “prospect rank” can be set based on the three levels of A, B, and C for example in an order of the prospects of the contract conclusion from the higher ones.

As shown in FIGS. 4A and 4B, the new input template has an “update as a continued negotiation” key, an “update as a contract conclusion” key, and a “delete from the mobile phone as cancellation” key. When the business transaction representative stops the negotiation data input in the middle of the input, then the business transaction representative selects the “update as a continued negotiation” key. When the negotiation leads to the contract conclusion, then the “update as a contract conclusion” key is selected. When the negotiation fails and the new negotiation information is desirably deleted, then the “delete from the mobile phone as cancellation” key can be selected.

When the “update as a continued negotiation” key is selected, then the mobile terminal 105 sends the new negotiation information in the middle of the input through the new input template to the management server 101. The management server 101 registers the received new negotiation information in the middle of the input in the negotiation data list to update the list. When the corresponding building in the negotiation management map shown in FIG. 2A has a display method not included in the display method to display the building 204 being negotiated, then the management server 101 changes the display method to the one for the building 204 being negotiated. Thereafter, when there is an access from the mobile terminal 105, the management server 101 sends an updated negotiation data list.

When the “update as a contract conclusion” key is selected, the mobile terminal 105 can send the new negotiation information for which the input through the new input template is completed to the management server 101 and can subsequently display the contract conclusion input template. This consequently allows the business transaction representative to start, after the data input of the new negotiation information, the data input of the contract conclusion input template. The mobile terminal 105 also may the new negotiation information for which the input is completed through the new input template to the management server 101 to subsequently display a confirmation message to confirm whether or not to input the contract conclusion information.

The management server 101 can update the received new negotiation information as a contract conclusion and can delete, from the new negotiation data list, the record of the customer for whom the contract is concluded. This consequently prevents the mobile terminal 105 from displaying the item of the customer in the new negotiation data list. When the corresponding building in the negotiation management map shown in FIG. 2A has a display method that is not the one showing the building 204 being negotiated, then the management server 101 updates the display method as a display method showing the building 204 being negotiated.

When the “delete from the mobile phone as cancellation” key is selected, the mobile terminal 105 deletes the new negotiation information and sends a deletion instruction to the management server 101. When the record of the customer is registered in the new negotiation data list, then the management server 101 deletes the customer record from the new negotiation data list. The management server 101 also updates, regarding the corresponding building in the negotiation management map shown in FIG. 2A, as the one having a display method showing a building for which the contract is not yet concluded. Another configuration also may be used in which the selection of the “delete from the mobile phone as cancellation” key is followed by the display by the mobile terminal 105 of the confirmation message showing whether or not the deletion is allowed.

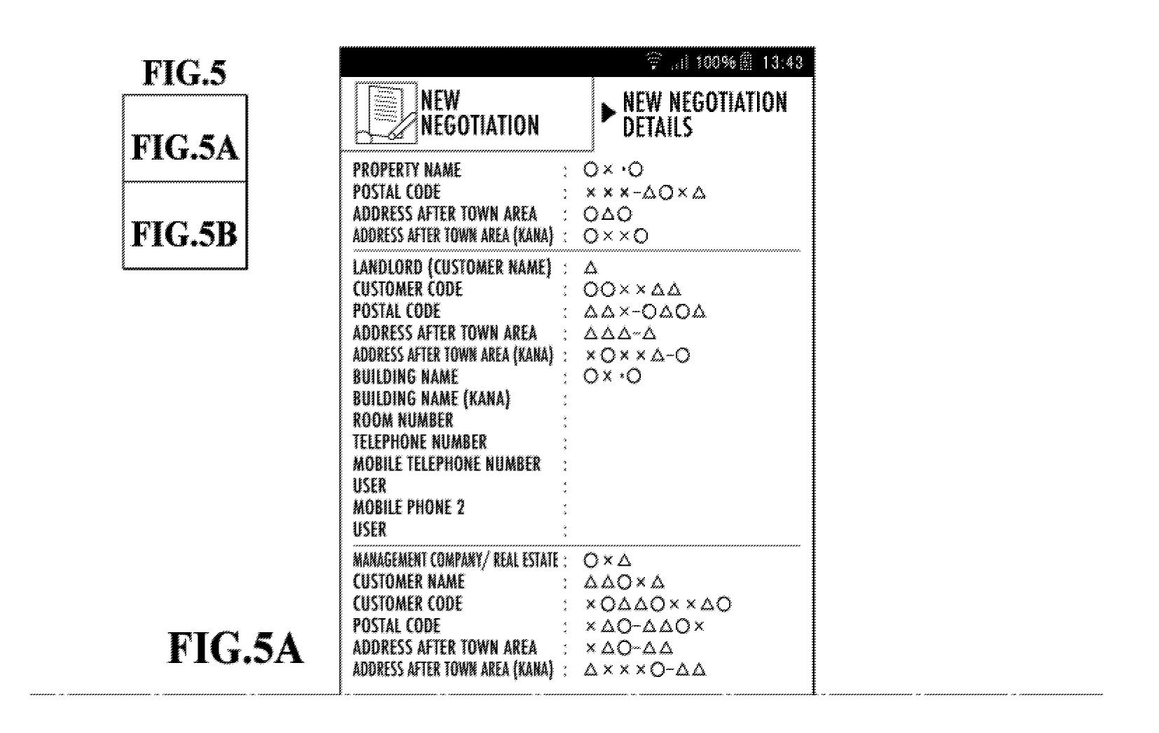

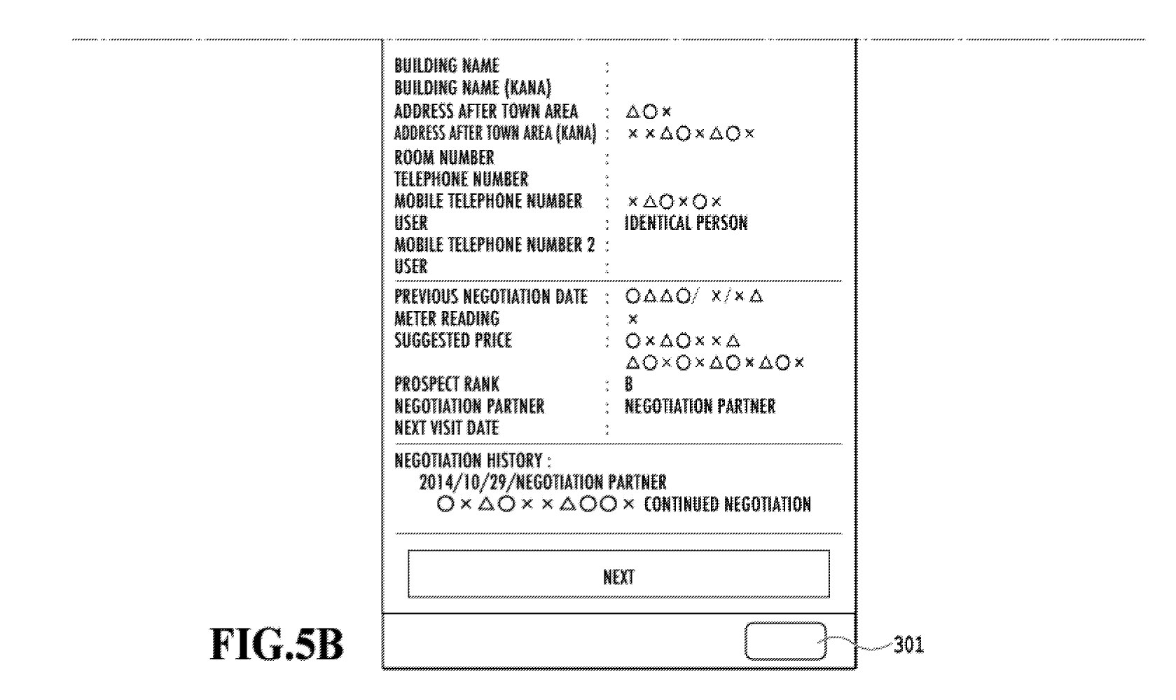

When the customer-related record displayed in the new negotiation data list shown in FIG. 3B is touch-selected, then the mobile terminal 105 can display the detailed screen of the new negotiation information for the customer. FIGS. 5A and 5B illustrate the detailed screen of the new negotiation information. When the “next” key is selected in the detailed screen in FIGS. 5A and 5B, then the new input template in the middle of the input is displayed. Thus, the business transaction representative can resume the data input stopped in the middle of the input.

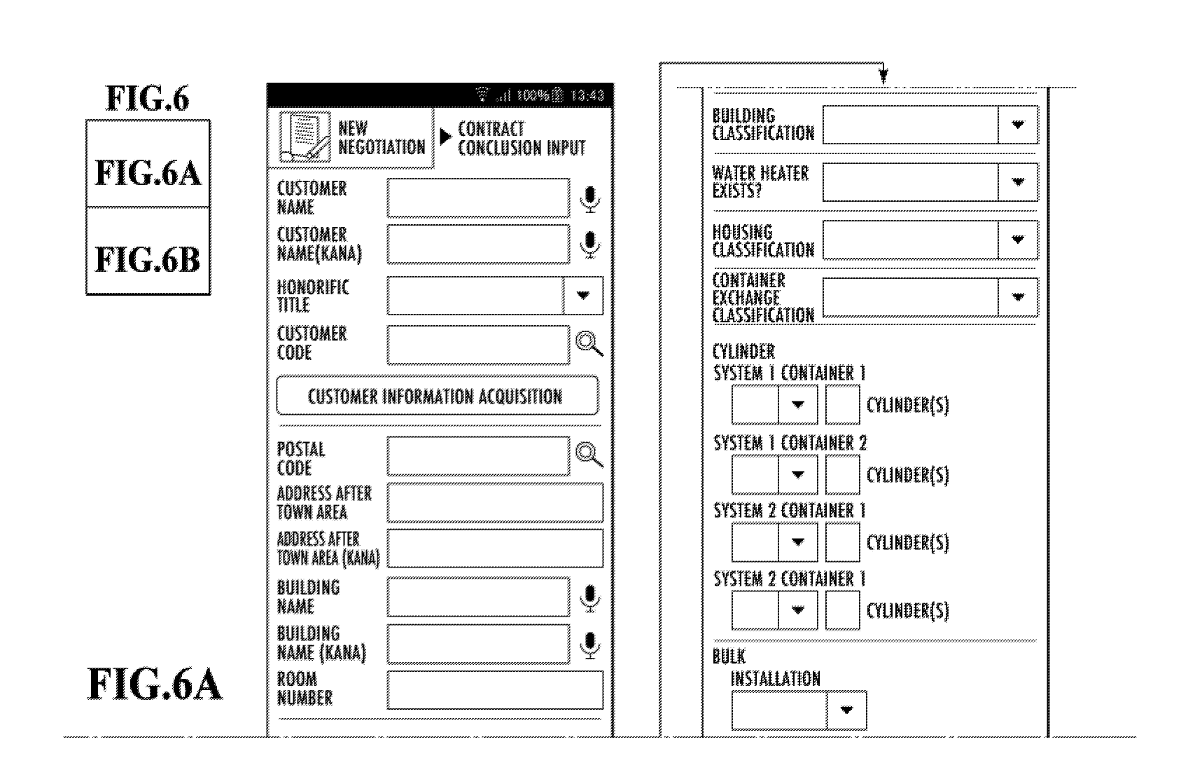

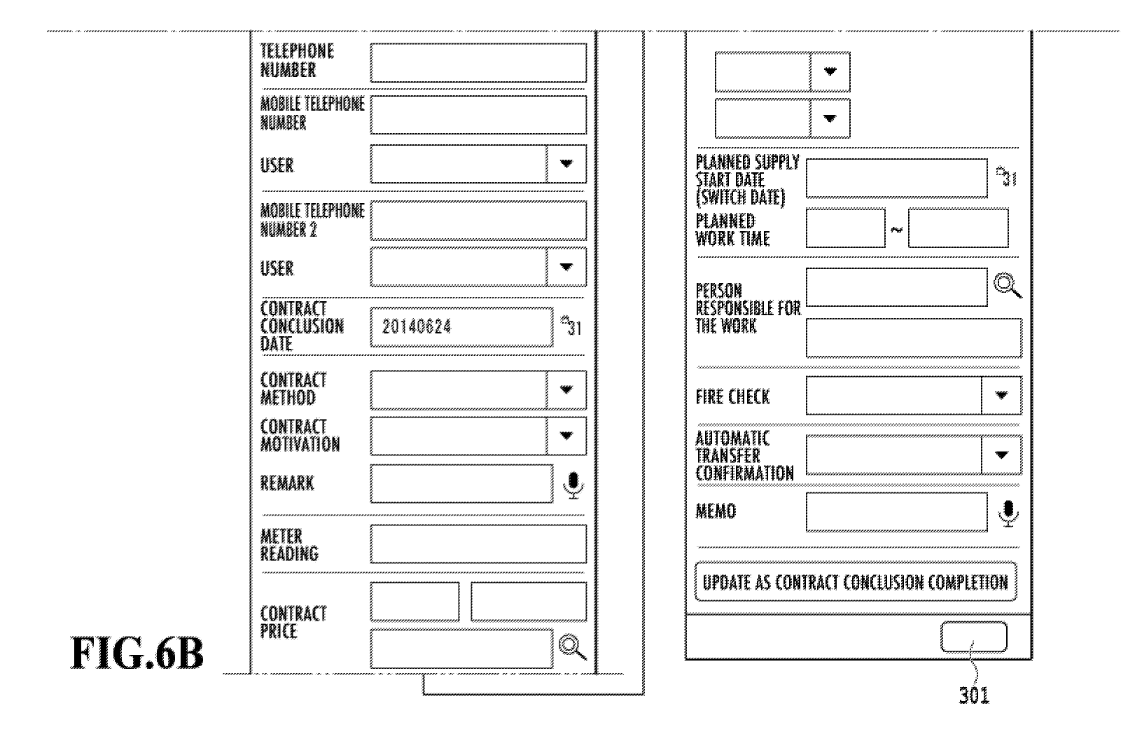

FIGS. 6A and 6B illustrate the contract conclusion input template used for the transfer from the new input template. As described above, when the “update as a contract conclusion” key is selected in the new input template, then the contract conclusion input template shown in FIGS. 6A and 6B is displayed. In the contract conclusion input template, the input contents in the new input template are reflected with regard to the corresponding input contents. Thus, the business transaction representative can additionally input a required item.

From the input items for the “contract method” in FIGS. 6A and 6B, an item such as introduction, D2D, new creation, inquiry, or a call center for example can be selected. From the input items for the “contract motivation” in FIGS. 6A and 6B, an item such as the company's service, the price (condition), the reliability of the employees of the company, the complaint to the current supply company, or others can be selected. From the input items for the “building classification” in FIGS. 6A and 6B, an item such as a specific underground mall for example, a general multiple-unit residential building, a general housing, a specific basement room for example, a superhigh-rise building, a high-rise building, a specific large-scale building, a specific medium-scale building, a specific public building, an industrial building and a general business building, or a cylinder storehouse can be selected. From the input item for “water heater exists?” in FIGS. 6A and 6B, “No” or “Yes” can be selected. From the input items for the “housing classification” in FIGS. 6A and 6B, an input item such as a self-owned home, a leased house, a company housing, an apartment, a condominium building, a public housing, a city-run or prefecture-run or public facility, a one room, personal consumption, or others can be selected. From the input items for the “fire check” in FIGS. 6A and 6B, an item such as OK, block plate, cylinder relocation, or block plate+cylinder relocation can be selected. From the input items for the “automatic transfer confirmation” in FIGS. 6A and 6B, an input item such as “already collected” or “the current transfer day” can be selected.

When the input of the contract conclusion input template is completed and the “update as contract conclusion completion” key is selected, then the mobile terminal 105 sends the contract conclusion information for which the input is completed through the contract conclusion input template to the management server 101. When the contract conclusion is the contract conclusion based on the new negotiation, then the management server 101 updates the received contract conclusion information as contract conclusion completion and uses the new negotiation data to create the reception of “newly create new”. The management server 101 updates, regarding the corresponding building in the negotiation management map shown in FIG. 2A, the display method to a display method showing the building 203 being covered by the contract.

By the above procedure, the processing of the management system according to the present invention from the new negotiation to the contract conclusion is completed.

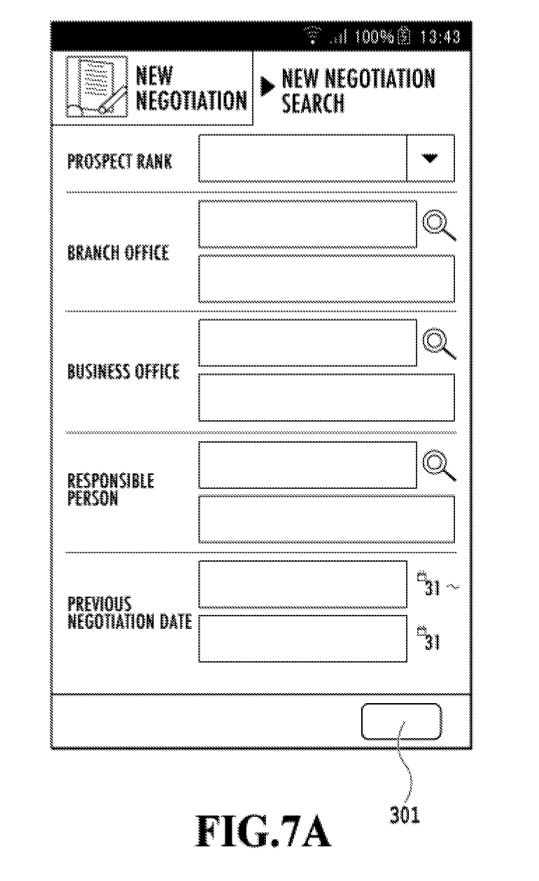

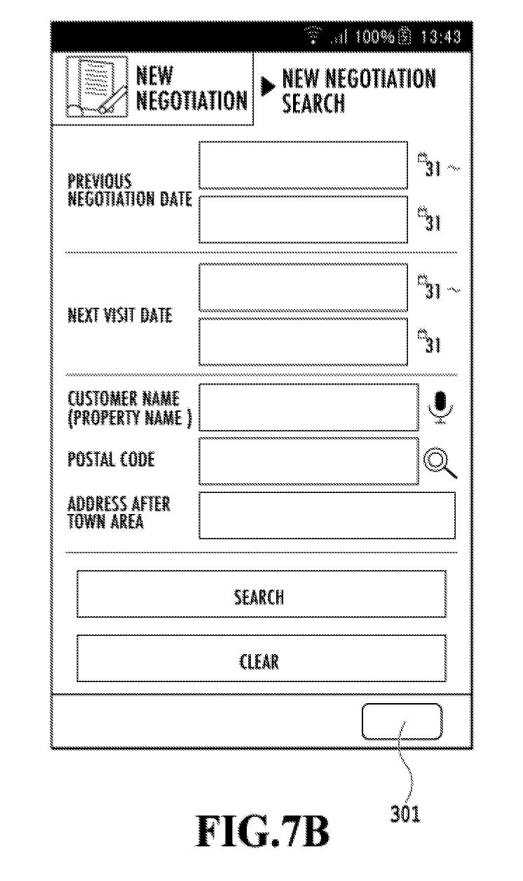

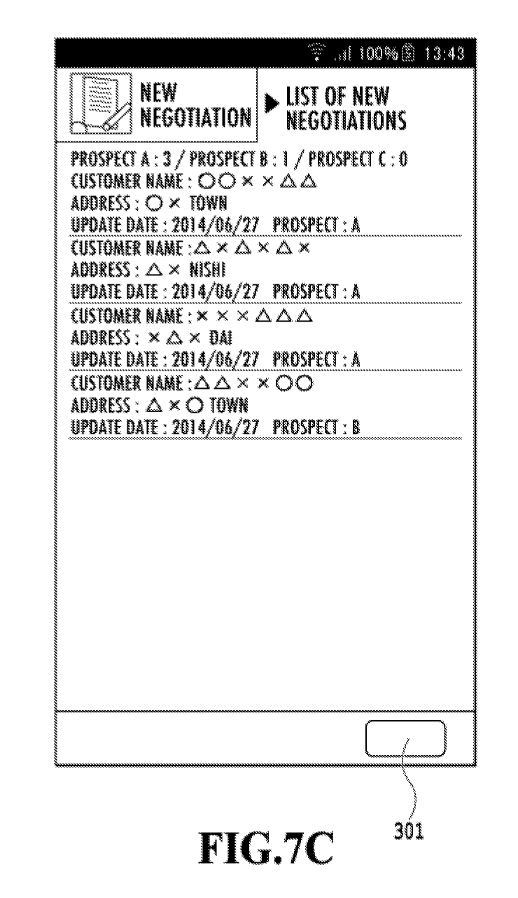

When the “search” key is selected in FIG. 3C, the mobile terminal 105 displays the screen that displays the search condition input template as shown in FIGS. 7A and 7B. Within the search condition input template, an item such as the prospect rank, the branch office, the business office, the responsible person, the negotiation date, the customer name (property name), the postal code, or the address can be inputted. After the input through the search condition input template, when the “search” key shown in FIG. 7B is selected, the mobile terminal 105 limits the search of the new negotiation data list based on the search condition as shown in FIG. 7C to display the new negotiation data list matching the search condition. When the “clear” key shown in FIG. 7B is selected, then the mobile terminal 105 can clear all of the search conditions.

When the customer-related record is selected from the searched negotiation data list shown in FIG. 7C, the detailed screen showing the details of the negotiation situation for the record can be displayed as shown in FIGS. 5A and 5B to display the customer-related new input template in the middle of the input. Thus, the business transaction representative can resume the stopped data input.

### Switch Negotiation Through Contract Conclusion to Closing

Next, the following section will describe the flow of the processing of the management system according to the present invention from the switch negotiation through the contract conclusion to the closing.

Returning to FIG. 3A, when the switch negotiation input item is selected in the above menu screen, the mobile terminal 105 displays a switch negotiation data list from within the negotiation data list received from the management server 101. As in the above case, the function key can be selected to use the “search” key to perform a search operation to thereby limit the search of the switch negotiation data list to perform the data input of the switch negotiation information. Also as in the above case, when the customer record in the switch data list is selected, then the mobile terminal 105 can display the detailed screen showing the details of negotiation situation in the record to display the new input template in the middle of the input. Thus, the business transaction representative can resume the stopped data input of the switch input template.

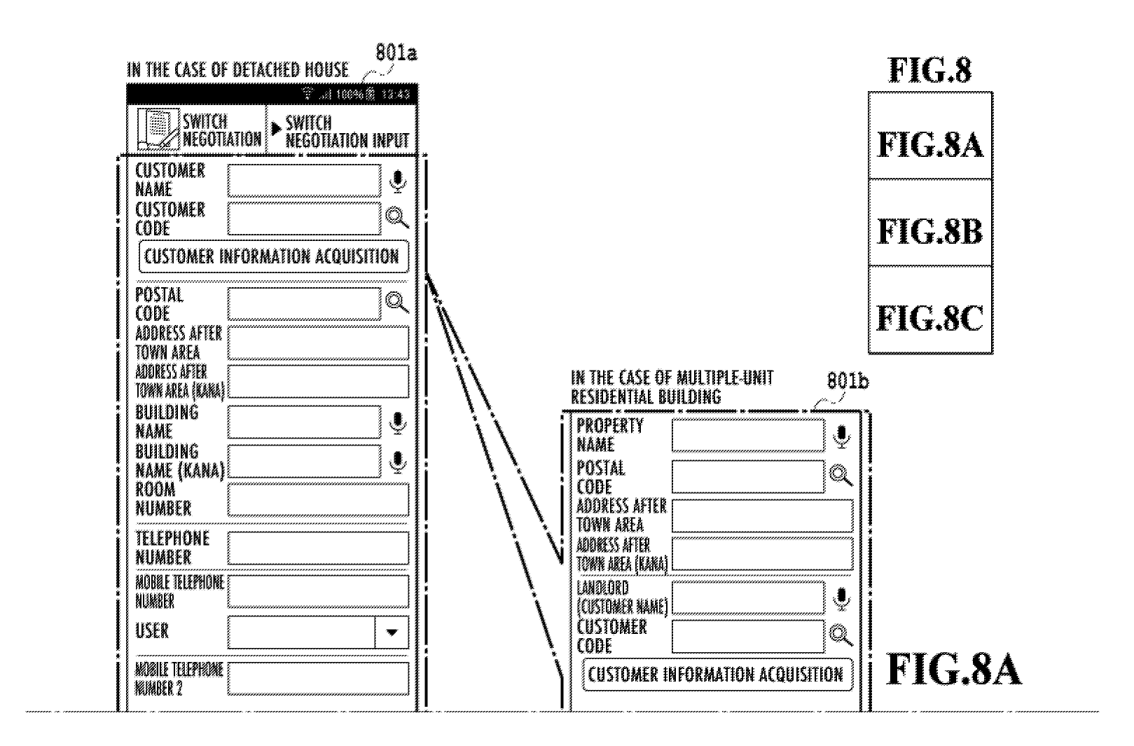

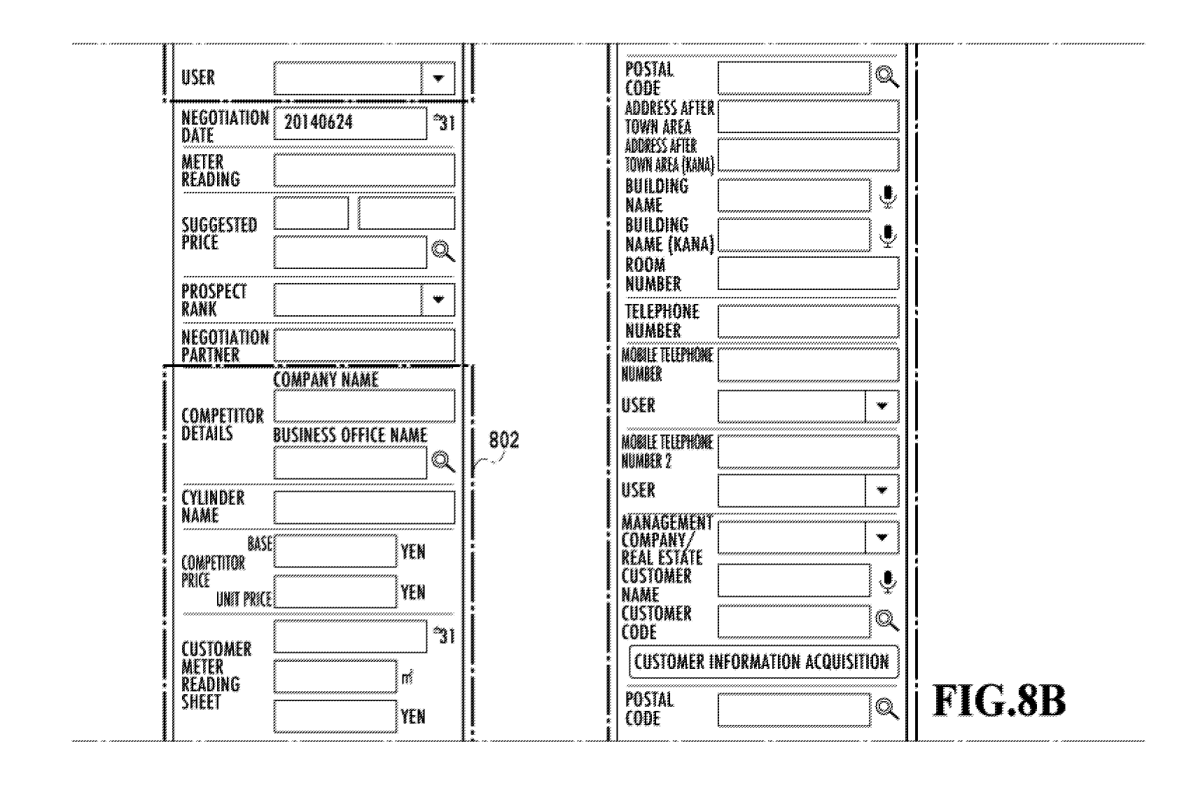

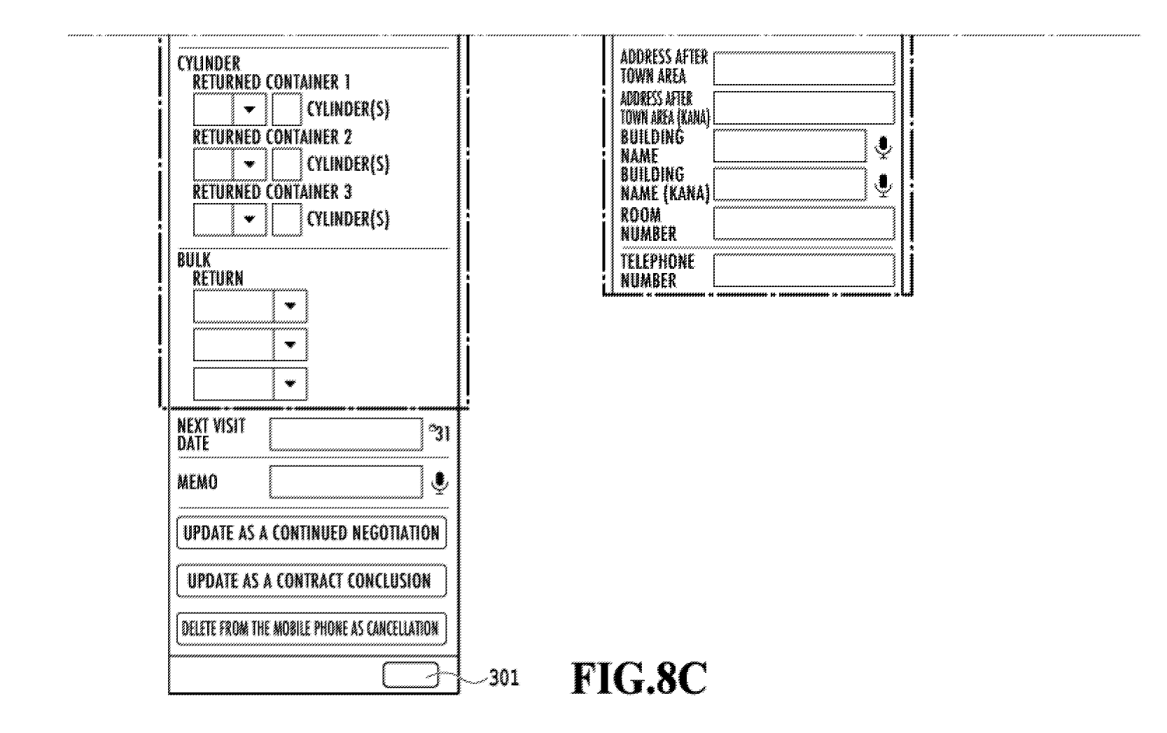

FIGS. 8A to 8C illustrate the switch input template. The mobile terminal 105 can display the switch input template by the operation as in the data input of the new negotiation information. The switch input template for the “detached house” and the switch input template for the “multiple-unit residential building” are different only in the portions of input item groups 801a and 801b and the other portions are the same. As illustrated in FIGS. 8A to 8C, the switch input template is different from the new input template shown in FIGS. 5A and 5B in having the input item group 802.

From the input item for the “cylinder return container” in FIGS. 8A to 8C, an item such as 20 containers, 30 containers, 50 containers, 450 containers, or 500 containers can be selected. From the input item for the “bulk return” in FIGS. 8A to 8C, an item such as 0 kg, 1 kg, 50 kg, 80 kg, 145 kg, or 150 kg can be selected.

As shown in FIGS. 8A to 8C, as in the new input template, the switch input template has the “update as a continued negotiation” key, the “update as a contract conclusion” key, and the “delete from the mobile phone as cancellation” key. By selecting the “update as a contract conclusion” key, the mobile terminal 105 can send the switch negotiation information for which the input is completed through the switch input template to the management server 101 to subsequently display the contract conclusion input template. As in the above description, the mobile terminal 105 also may send the switch negotiation information for which the input is completed through the switch input template to the management server 101 to subsequently display a confirmation message asking whether or not the contract conclusion information is inputted. When the corresponding building in the negotiation management map shown in FIG. 2A has a display method not showing the building 204 being negotiated, then the management server 101 updates the display method to a display method showing the building 204 being negotiated.

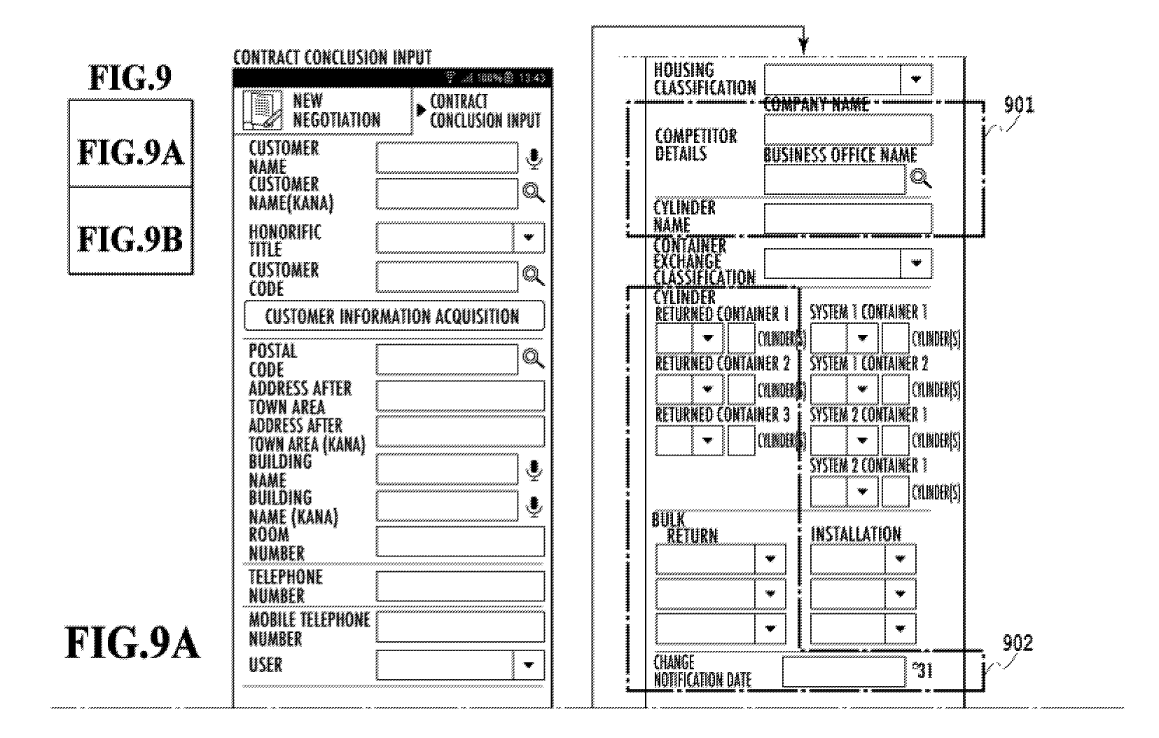

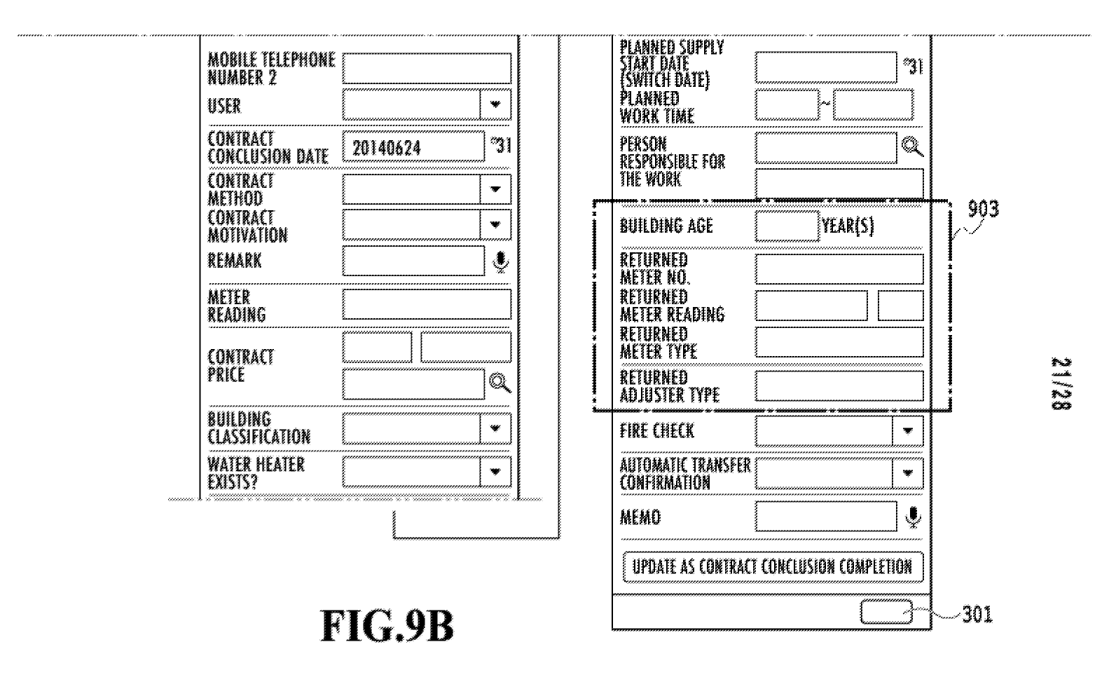

FIGS. 9A and 9B illustrate the contract conclusion input template for the transfer from the switch input template. As shown in FIGS. 9A and 9B, the contract conclusion input template for the transfer from the switch input template is different from the contract conclusion input template shown in FIGS. 6A and 6B in having the input item groups 901, 902, and 903.

When the “update as a contract conclusion” key is selected through the switch input template, then the contract conclusion input template shown in FIGS. 8A to 8C is displayed. The contract conclusion input template shows the corresponding input contents reflecting the input contents inputted through the switch input template. Thus, the business transaction representative can additionally input a required item. From the input items for the “container exchange classification” in FIGS. 9A and 9B, an item such as “total”, “half”, “total+backup”, “half at the same side”, “half in different number”, “bulk”, or “tank” can be selected.

When the input through the contract conclusion input template is completed and the “update as a contract conclusion” key is selected, the mobile terminal 105 can send the contract conclusion information for which the input is completed through the contract conclusion input template to the management server 101 to subsequently display the closing input template. The management server 101 updates the display method of the corresponding building in the negotiation management map shown in FIG. 2A to a display method showing the building 203 being covered by the contract.

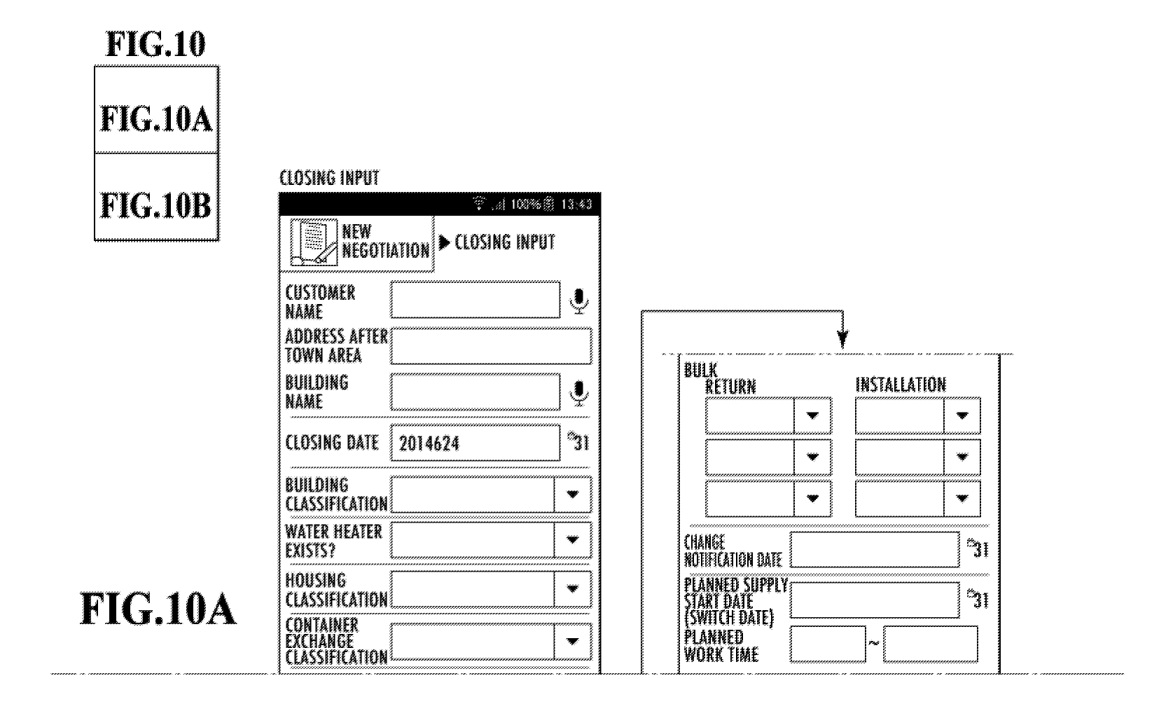

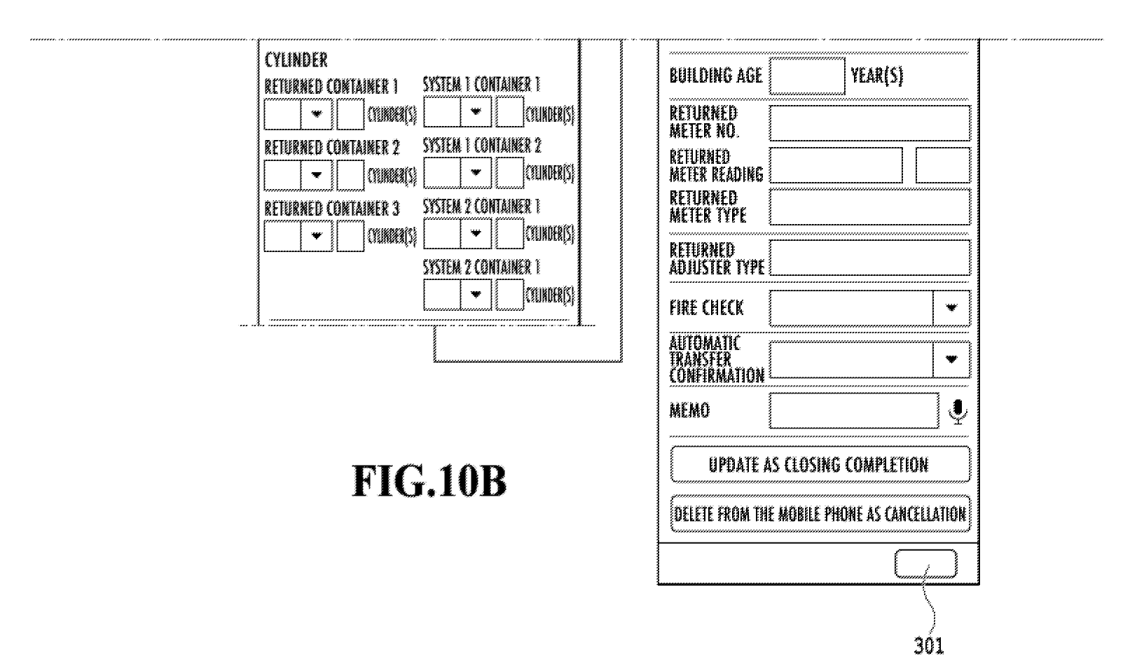

FIGS. 10A and 10B illustrate the closing input template. The closing input template displays the corresponding input contents reflecting the input contents inputted through the contract conclusion input template. Thus, the business transaction representative can additionally input a required item.

When the input through the closing input template is completed and an “update as closing completion” key shown in FIGS. 10A and 10B is selected, then the closing information for which the input is completed through the closing input template can be sent to the management server 101 to subsequently display a message asking whether or not a specific commerce transaction is confirmed. When the management server 101 receives the closing information, then the management server 101 update the information as the closing-completed one and creates the reception of the “new switching” related to the customer. The data from the switch negotiation through the contract conclusion to the closing is reflected on the formal registration information for the “new switching”.

By the above processing, the processing of the management system according to the present invention from the switch negotiation through the contract conclusion to the closing is completed.

### Regarding a Contract Conclusion Input Item and a Closing Input Item

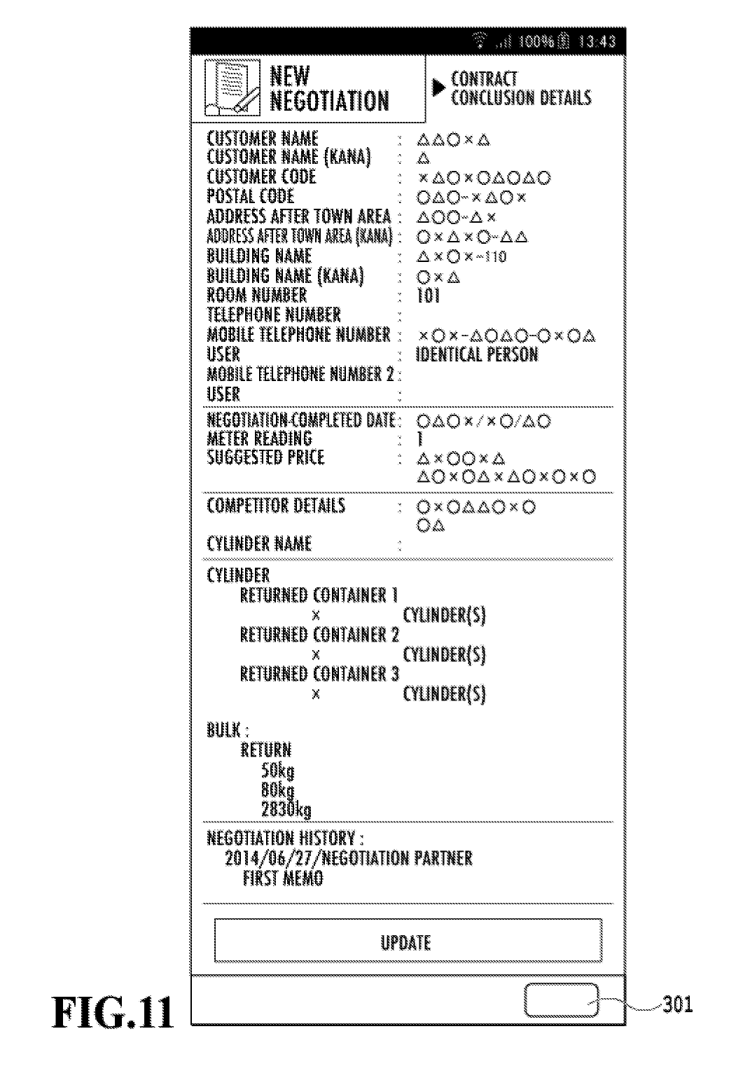

Returning to FIG. 3A, when the contract conclusion input item selected in the above menu screen, the mobile terminal 105 displays the contract conclusion data list from among the negotiation data list received from the management server 101. As in the above case, by selecting the function key 301 to use the “search” key to perform the search, the search of the contract conclusion data list can be limited to subsequently perform the data input of the contract conclusion information. When the customer record in the contract conclusion data list is selected, the mobile terminal 105 displays the detailed screen showing the details of the contract conclusion situation in the record. FIG. 11 illustrates the detailed screen showing the details of the contract conclusion situation. When the “update” key in the detailed screen shown in FIG. 11 is selected, then the contract conclusion input template regarding the customer is displayed. Thereafter, the contract conclusion information can be inputted through the contract conclusion input template as described above.

When the closing input item is selected in the above menu screen, the mobile terminal 105 displays the closing data list from the negotiation data list received from the management server 101. As in the above case, by selecting the function key 301 to use the “search” key to perform a search operation, the search of the closing data list can be limited to subsequently input the closing data.

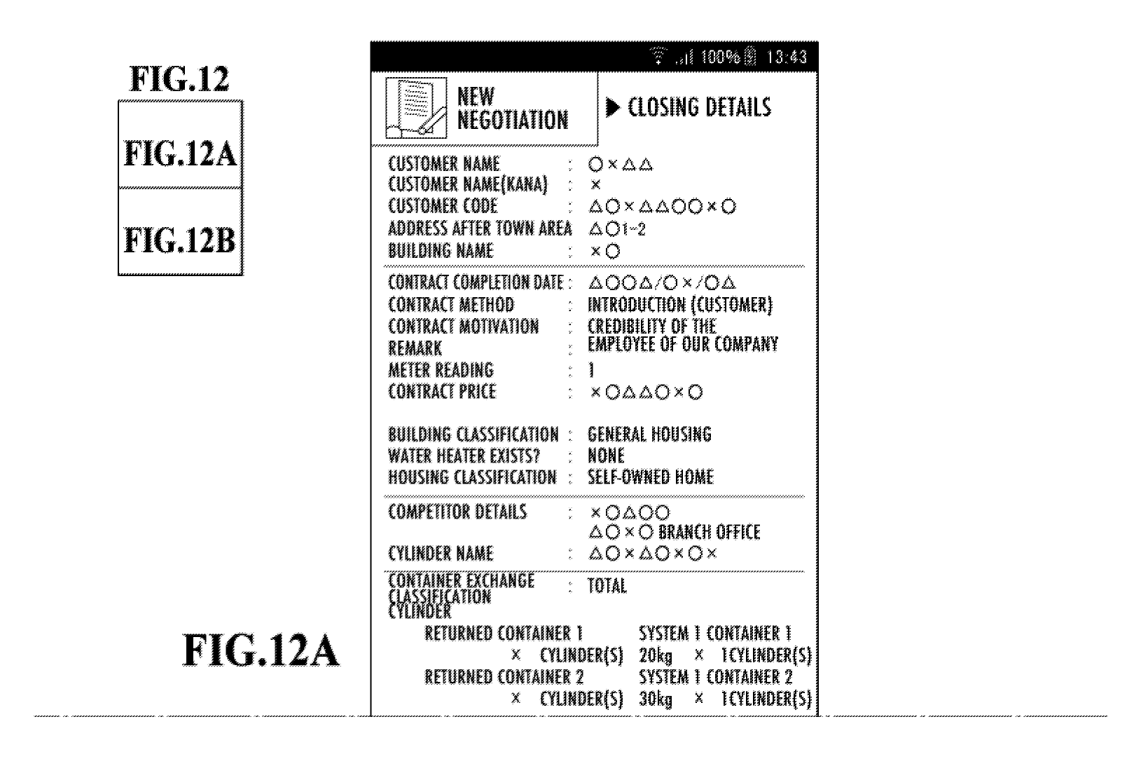

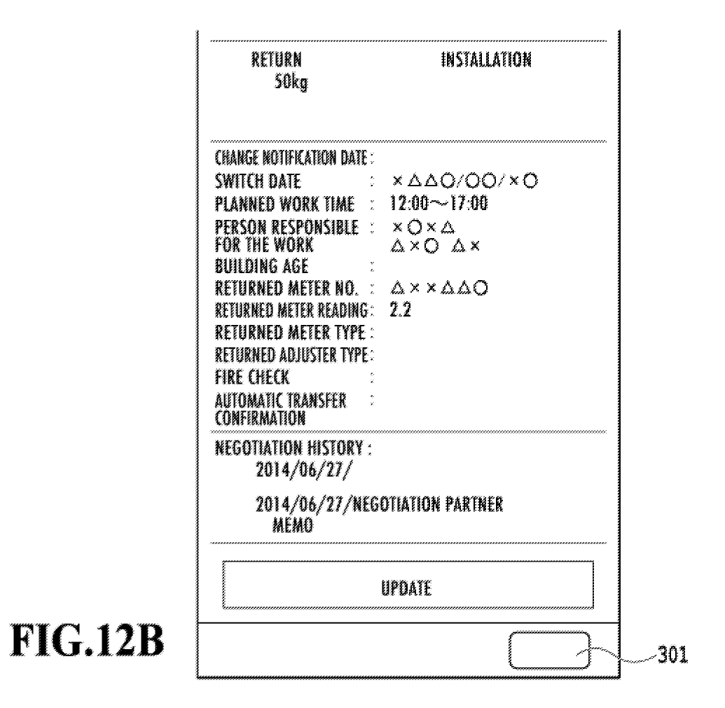

When the customer record in the closing data list is selected, then the mobile terminal 105 displays the detailed screen showing the details of the closing situation in the record. FIGS. 12A and 12B illustrate the detailed screen showing the details of the closing situation. When the “update” key in the detailed screen shown in FIGS. 12A and 12B is selected, then the closing input template is displayed. Thereafter, the closing information can be inputted through the closing input template as described above.

As described above, the new input template, the switch input template, the contract conclusion input template, and the closing input template have been described. However, each input template also may additionally include an item to input the area code of the building being negotiated.

### Data Output Through Client Computer

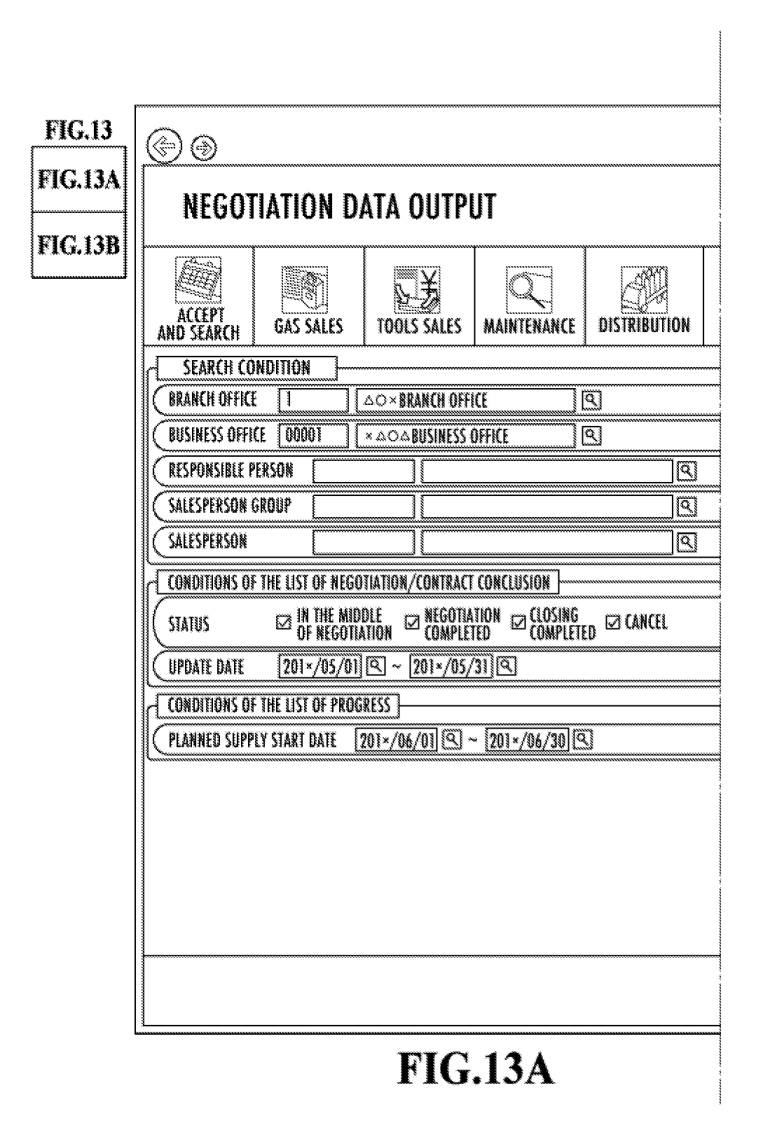

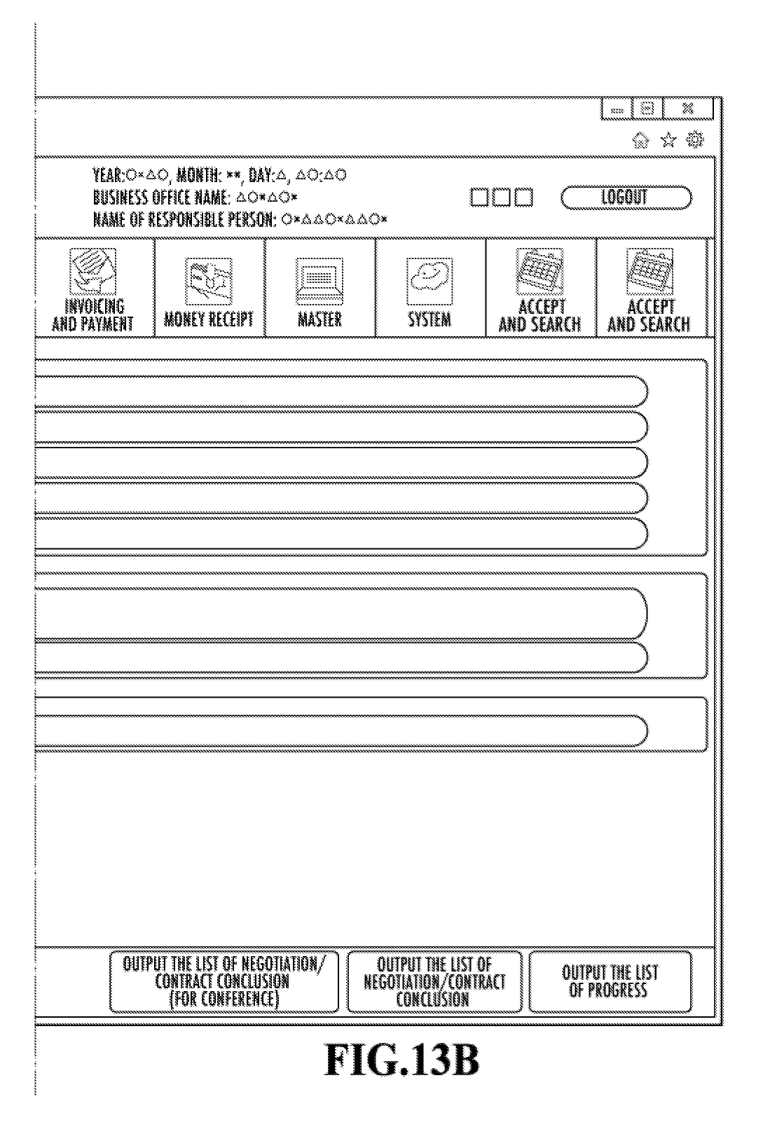

FIGS. 13A and 13B illustrate a data output screen in a client computer. The client computer 103 can search the formal registration information related to “newly create new” or “new switching” registered in the management server 101 based on various search conditions and can output various business forms reflecting the register information inputted at the negotiation stage without requiring the input of any register information inputted at the negotiation stage.

The client computer 103 also can select installation work companies that can handle an installation work required for the “newly create new” or “new switching” item to display the list thereof. The management server 101 includes therein schedules of a plurality of installation work companies registered in advance and the plurality of installation work companies are associated with postal codes and area codes, respectively. This allows the management server 101 can select installation work companies associated with postal codes or area codes inputted through each input template to display as a search result, from among these installation work companies, an installation work company for which a date on which the installation work is possible in the schedule of the installation work company matches a planned supply start date inputted through each input template. This provides, in contrast with a conventional case in which the completion of the negotiation is followed by the input of any information obtained through the negotiation to search and select an installation work company that can handle the installation work, an efficient selection of an installation work company that can provide the installation work without requiring such a cumbersome operation.

1. A management system comprising a management server and a mobile terminal that can communicate with the management server via a network,
the management server is configured to:
receive an access request from the mobile terminal via the network, the access request including a business office identifier for identifying a business office to which a business transaction representative belongs,
receive a periphery map of the mobile terminal based on a location of the mobile terminal,
create a negotiation data list showing a list of customers in the middle of the negotiation, the negotiation data list being associated with the business office identifier,
create a negotiation management map showing a location of a building corresponding to each customer of the negotiation data list on the periphery map,
send the negotiation data list, a customer information input template and the negotiation management map to the mobile terminal, the customer information input template including a new input template to input new negotiation information related to a new negotiation for a customer for which a gas contract has been not yet concluded, a switch input template to input switch negotiation information related to a switch negotiation for switching the gas contract from another gas supply company, a contract conclusion input template to input contract conclusion information relates to a contract conclusion, a closing input template to input closing information related to the closing, and a search condition input template to input search condition, the contract conclusion input template being configured to reflect information input to the new input template or the switch input template, the closing input template being configured to reflect information input to the contract conclusion input template,
the mobile terminal is configured to:
receive the negotiation data list, the customer information input template and negotiation management map,
display the negotiation management map,
display the customer information input template corresponding to the building in response to receive a first user input for the building displayed to the negotiation management map,
receive a second user input to the customer information input template, and
send the customer information input template for which the second user input was received,
the management server is configured to
update the negotiation data list based on the customer information input template.

2. (canceled)

3. The management system according to claim 1, wherein:
the management system further includes a client computer that can communicate with the management server via the network, and
the client computer can search the formal registration information from the management server.

4. A method carried out in a management system including a management server and a mobile terminal that can communicate with the management server via a network, the method comprising:
receiving, by the management server, an access request from the mobile terminal via the network, the access request including a business office identifier for identifying a business office to which a business transaction representative belongs,
receiving, by the management server, a periphery map of the mobile terminal based on a location of the mobile terminal,
sending, by the management server, a negotiation data list showing a list of customers in the middle of the negotiation, the negotiation data list being associated with the business office identifier,
creating, by the management server, a negotiation management map showing a location of a building corresponding to each customer of the negotiation data list on the periphery map,
sending, by the management server, the negotiation data list, a customer information input template and the negotiation management map to the mobile terminal, the customer information input template including a new input template to input new negotiation information related to a new negotiation for a customer for which a gas contract has been not yet concluded, a switch input template to input switch negotiation information related to switch negotiation for switching the gas contract from another gas supply company, a contract conclusion input template to input contract conclusion information relates to a contract conclusion, a closing input template to input closing information related to the closing, and a search condition input template to input search condition, the contract conclusion input template being configured to reflect information input to the new input template or the switch input template, the closing input template being configured to reflect information input to the contract conclusion input template,
receiving, by the mobile terminal, the negotiation data list, the customer information input template and negotiation management map,
displaying, by the mobile terminal, the negotiation management map,
displaying, by the mobile terminal, the customer information input template corresponding to the building in response to receive a first user input for the building displayed to the negotiation management map,
receiving, by the mobile terminal, a second user input to the customer information input template,
sending, by the mobile terminal, the customer information input template for which the user input was received,
updating, by the management server, the negotiation data list based on the customer information input template.

5. (canceled)

6. The method according to claim 4, wherein the management system further includes a client computer that can communicate with the management server via the network, and
the method further comprising searching, by the client computer, the formal registration information from the management server.
